(19) United States
(12) Patent Application Publication
(10) Pub. No.: US 2010/0313469 A1
(43) Pub. Date: Dec. 16, 2010

(54) ADHESIVE-BASED DECORATIVE LANDSCAPING PRODUCT AND METHOD

(76) Inventor: Karen Nixon-Lane, Plymouth, MI (US)

Correspondence Address: Brinks Hofer Gilson & Lione/Ann Arbor, 524 South Main Street, Suite 200, Ann Arbor, MI, 48104, US

(21) Appl. No.: 12/815,822

(22) Filed: Jun. 15, 2010

Related U.S. Application Data
(60) Provisional application No. 61/268,664, filed on Jun. 15, 2009.

(51) Int. Cl. A01G 13/00; A01G 1/00

(52) U.S. Cl. 47/9; 47/1.1 R; 47/58.1 R

(57) ABSTRACT

A ground cover or landscaping material that includes a plurality of loose particles that are combined with a water activated adhesive component. When the water activated adhesive component is activated by contacting the ground cover or landscaping material with water the adhesive cures and secures the loose particles together. The water activated adhesive allows for the use of light weight particles that would be easily displaced when exposed to wind and rain or blow by lawn mowers or leaf blowers, absent being fixed together by the adhesive. Suitable particles include mulch, wood chips and synthetic materials.

### RELATED APPLICATIONS

The present patent document claims the benefit of the filing date under 35 U.S.C. §119(e) of Provisional U.S. Patent Application Ser. No. 61/268,664, filed Jun. 15, 2009, which is hereby incorporated by reference.

### TECHNICAL FIELD

The present invention relates to landscaping materials. More particularly, the present invention relates to a decorative ground cover material with enhanced dispersion-proof, soil-erosion, installation and foot-friendly properties.

### BACKGROUND ART

It is often desirable to suppress plant growth and provide ground cover in certain ground regions for ornamentation, erosion control, and fire protection. For such purposes, ground cover is typically used in areas along the sides of a driveway or around the periphery of a porch or building. Other uses of decorative ground cover or landscaping materials include weed and moisture control and ornamentation around bushes, trees, flower beds, signage, landscaping areas, etc.

Different types of ground cover or landscaping material applications generally include covering ground regions or areas with ornamental pebbles, stones, lava rocks, mulch, wood chips, or other natural and/or artificial ground covering or landscape materials. Light weight ground cover or landscaping materials such as mulch and wood chips are relatively easy to install and rake into position. However, the same light weight nature allows such ground cover or landscaping materials to be easily displaced when exposed to wind and rain or blown by lawn mowers or leaf blowers. Furthermore, when trimmings from bushes and shrubs, grass clippings, leaves, etc. collect on the surface of the mulched or wood chip areas, it is very difficult to clean up these areas without also removing a portion of the mulch or wood chips. Therefore, mulch and wood chips, while being colorful, environmentally friendly, and relatively easy to apply, are not ideal landscaping materials.

Generally all types of ground cover or landscaping materials have to be maintained and replaced periodically so that they remain in the area that they are intended to cover. In addition natural ground cover or landscaping materials such as mulch and wood chips are subject to weathering discoloration (fading) and decomposition so that such materials have to be periodically replenished and/or replaced.

Various types of synthetic ground cover have been developed to overcome many of these deficiencies commensurate with natural types of ground cover.

U.S. Pat. No. 5,910,514 to Greenberg et al. discloses an example of synthetic wood chips that consist of rubber particles and a colorant that is used to give the particles the appearance of natural mulch. The synthetic wood chips are formed by shredding larger pieces of vulcanized rubber and are spread over the intended landscape in the same manner that traditional natural mulches are spread. These synthetic wood chips have the same problem as traditional ground covering in that they do not include a component by which the products can be anchored to the ground that they cover. Thus, the synthetic wood chips suffer the same problem presented by natural wood chips, pebbles and rocks, namely, that they are subject to displacement by wind, rain, or human or animal traffic.

Decorative stones are frequently applied to landscaping areas instead of mulch, because of stone's more permanent characteristics. Stones do not decompose or reduce, eliminating the need for regular reapplication. Stones, for the most part, stay in place when cleaning up clippings, leaves, etc. with a leaf blower. Stones also do not easily dislodge from position as a result of rain, wind and other routine weather incidents.

However, the weight and solid nature of stones, i.e., the very properties that make them a frequently utilized alternative to mulch, has inherent drawbacks. These include the increased work associated with installing heavy stones, the danger of stray, displaced stones being thrown by lawnmower blades, trimmers, etc., the work associated with removing stones when desired, and the discomfort caused from stepping on stones within or around these areas without proper footwear.

Application of stones is a painstaking task, requiring transporting and laying down of thousands of pounds of material. This deters most people from attempting stone application themselves. Stones are typically delivered by truck, dumped, and then hauled in individual loads to various areas, where they are shoveled into place, then raked into position. When kicked up by mowers, air blowers, etc, stones become dangerous flying objects, and their weight makes them extremely difficult to remove from the ground into which they settle over time. These factors make replacing traditional mulch with stones a less than ideal solution.

Most types of ground cover or landscaping materials, including crushed stones, lava rock, mulch and wood chips to name a few are frequently used around swimming pools and throughout play areas. When these materials are stepped on without footwear they can cause considerable if not significant pain and discomfort.

The present invention is directed to a ground cover or landscaping material that includes the desired features of both light weight and heavy weight ground cover or landscaping materials and avoids the drawbacks associated with each.

### DISCLOSURE OF THE INVENTION

According to various features, characteristics and embodiments of the present invention which will become apparent as the description thereof proceeds, the present invention provides a ground cover or landscaping material that includes a volume of loose particles and a water activated adhesive component that when activated and cured secures the loose particles together.

The present invention further provides a method of applying a ground cover or landscaping material to a surface area which involves the steps of:

providing a ground cover or landscaping material that comprises a volume of loose particles and a water activated adhesive component that when activated and cured secures the loose particles together;

applying the ground cover or landscaping to a surface area;

applying water to the ground cover or landscaping material to activate the adhesive composition; and

allowing the adhesive composition to cure and fix the loose particles together.

The present invention also provides a ground cover or landscaping material covering a surface area which includes a volume of particles that are fixed together by a water activated adhesive that has been water-activated.

### BEST MODE FOR CARRYING OUT THE INVENTION

The present invention is directed to ground cover or landscaping materials that are designed to be relatively easily applied/installed and thereafter resist being displaced when exposed to wind and rain or blow by lawn mowers or leaf blowers or swept by brooms or washed with a water stream. As used herein to describe the present invention, the terms “ground cover” and “landscape materials” are used synonymously.

The ground cover or landscaping materials of the present invention are loose particulate or granular materials that are combined with adhesive which secures the individual particles or granules of the ground cover or landscaping materials together.

While the ground cover or landscaping materials used according to the present invention can be any type of conventional ground cover or landscaping materials, the present invention is particularly useful in conjunction with light weight ground cover or landscaping materials, such as wood chips, mulch, synthetic materials, and the like. In this regard, such light weight ground cover or landscaping materials are easier to install than heavier ground cover or landscaping materials such as stone because of their weight. According to the present invention the prior disadvantages associated with light weight materials is overcome by the adhesive that is combined in or with the ground cover or landscaping materials and secures the individual particles or granules of the ground cover or landscaping materials together so that the light weight ground cover or landscaping materials will not be easily displaced when exposed to wind and rain or blow by lawn mowers or leaf blowers.

In areas such as around swimming pools or playgrounds or other play areas where people might walk bare foot or tend to fall on the ground while playing, the ground cover or landscaping materials can comprise synthetic soft or spongy materials that are used in combination or combination with an adhesive component. An example of a soft or spongy material is the synthetic mulch disclosed in U.S. Patent Application Publication No. 2001/0047051 to Greenberg et al., the complete disclosure of which is expressly hereby incorporated by reference.

According to one embodiment of the present invention the ground cover or landscaping materials can be pre-combined with the adhesive component. For example, the ground cover or landscaping materials of the present invention can be supplied or sold to consumers in a form in which the ground cover or landscaping materials are coated, impregnated, mixed with or otherwise combined with the adhesive in any suitable manner. In such an embodiment, the consumer can purchase the ground cover or landscaping materials of the present invention, apply the ground cover or landscaping materials to a desired area and thereafter activate the adhesive by for example wetting the ground cover or landscaping materials with water.

According to one embodiment the ground cover or landscaping material comprises a flexible porous base material in the form of particles that are saturated or impregnated with a water-activated adhesive that fills the porous areas of the particles. These particles can be applied to or combined together as the base material via a tackifier or at the colorant step as described herein. The adhesive-impregnated body can thereafter be coated with a thin, water-soluble substance that would wash away when the adhesive is being activated. The resulting adhesive-bonded ground cover or landscaping material would be as firm or hard as the adhesive being used, minus the “give” associated with the porous body itself. Thus, the flexibility of the adhesive composition and/or the characteristics/properties of the particulate material can be selected or adjusted to provide a desired flexibility for practical applications, i.e., whether or not the final product needs to be soft to walk on, or not.

According to an alternative embodiment the ground cover or landscaping materials and adhesive can be combined on site. Such an application might be more suitable for a commercial service that could combine the ground cover or landscaping materials and adhesive and apply the ground cover or landscaping materials of the present invention to a desired area and thereafter activate the adhesive by for example wetting the ground cover or landscaping materials with water or merely allow the ground cover or landscaping material to be exposed to rain or even humidity over time. It is also within the scope of the present invention to apply a liquid adhesive or adhesive solution to loose ground cover or landscaping material on site prior or after applying the ground cover or landscaping material to an area.

It is also possible to wet the ground cover or landscaping materials of the present invention with an aqueous solution rather than only water. For example the ground cover or landscaping materials could be wet with an aqueous solution that contains a herbicide, insect or rodent repelling chemicals, fertilizers, aromatic scent chemicals, etc. The combining of the ground cover or landscaping materials with the adhesive could either be done either before applying the ground cover or landscaping materials to an area or after the ground cover or landscaping materials were applied to an area. According to one embodiment a proportioner or injector could be used to combine herbicides, insect or rodent repelling chemicals, fertilizers, aromatic scent chemicals, etc. (on even an adhesive) into a water stream. A non-limited specific example is the use of an injector that can be coupled to a watering hose.

If desired the ground cover or landscaping materials of the present invention could be applied over a layer or mat of a weed-inhibiting material and thereafter raked into position prior to activating the adhesive with water. For example, the ground cover or landscaping material of the present invention can be applied over a weed barrier, underlayment material or the like which may further be coated with a water-activated adhesive to help secure the ground cover or landscaping material thereon. The water-activated adhesive provided on the week barrier, underlayment material or the like can the same (or different) as the water-active adhesive that is combined with the ground cover or landscaping material as discussed herein. It is also within the scope of the present invention to provide the ground cover or landscaping material of the present invention in the form of a base mat of a weed-inhibiting material with the particles pre-applied thereon with an adhesive that is not cured or fully cured, but could be activated and cured after the ground cover or landscaping material is positioned in place.

Once the adhesive is activated and cured the ground cover or landscaping materials of the present invention the applied ground cover or landscaping materials form a unified structure that remains in a fixed in position. The cured ground cover or landscaping material remains somewhat flexible, yet strong enough to endure a significant amount of weight, such as the weight of individuals, garden tools, wheelbarrows, trimmers, etc. The flexibility and strength of the cured ground cover or landscaping material provides for normal trimming, weeding, fertilization, etc. of bushes, flower beds and other landscaping items that are surrounded by the adhered material. In addition trimmings, grass, leaves and other debris from the surface of the adhered material can be removed with brooms, rakes, leaf blowers or water streams without disturbing the adhered material.

The adhesive utilized for the present invention may comprise a synthetic material such as a water activated form of polyvinyl alcohol (PVOH) in powdered or stranded form, or other water activated adhesives. The polyvinyl alcohol may also be provided in a “cooked” liquid version, in which case it could be sprayed directly onto the landscaping material at installation.

Polyvinyl alcohol useful for purposes of the present invention are available in many forms and in a variety of strengths from Dupont Corporation (Wilmington, Del.), Kuraray Corporation (Houston, Tex.), Nycon (Westerly, R.I.), and others. It is available in liquid, pre-cooked form, powder, and also in spun strands that are supplied in bundles of 30-50 thousand individual strands. The bundles are cut to size for the desired application, and then separated and applied via a nozzle. Strands of polyvinyl alcohol cut in ⅜ to ½ inch lengths can be added to the landscaping material at the colorant step, during the drying process, and blown onto the individual pieces of colored landscaping material, alone or in combination with the powdered form of the same material. This process will render each piece of landscaping material such that the PVOH or similar material is bonded onto the piece via the colorant, which is manufactured specifically to provide a permanent bond with the landscaping material. By using the colorant to facilitate holding the unactivated adhesive components onto the landscaping materials pieces, the use of a tackifier to accomplish this task becomes unnecessary. The pieces of dried, colored landscaping material once embedded with the PVOH strands and/or powdered PVOH, or similar adhesives, may then be packaged or coated as described above with a thin, water-soluble coating that will wash away at installation. Suitable colorants are available from Colorbiotics (Ames, Iowa), Interstar (Quebec, Canada), and other suppliers.

At installation, the material, once applied to the ground, may subsequently be activated with water or with aqueous PVOH (e.g. 4% by weight). The activation of the powdered PVOH, along with the aqueous solution, will form a strong bond with the portions of the PVOH strands that are embedded or attached to the surface of the individual pieces. When the PVOH solution comes in contact with the PVOH strands, a molecular bond is formed and the result is a meshed, interlaced agglomerate formed between the individual pieces of landscaping material.

Natural cementitious materials, such as Portland cement may be used to accomplish the same or similar result as that of PVOH. Dry, powdered cement can be applied to landscaping material using the process described above, in an amended mixture that contains ingredients to enhance strength, flexibility, quick drying time, shrinkage control, etc.

A highly polymer-modified cementitious material containing 20 percent polymer by weight of cement and 3-5% virgin polypropylene fibers would provide the desired characteristics.

Water-based, one or two-part epoxy is another adhesive type that can be used in the current invention, such as an epoxy slurry mix of REZI-WELD TYPE III DOT mixed with 4 parts fine, dry silica sand per volume.

Other water-activated adhesive can be used according to the present invention, including the Greenguard™ water-based adhesives available from 3M Company, in which case the adhesives would need to be provided in separated, pre-activated, non-aerosol state in order to be properly applied to the landscaping substrate for the current invention. Greenguard™ water-based adhesives and similar adhesives are particularly suitable because they will not harm the surrounding plants, nor wash off when moistened with pesticides, fertilizers, water or other organic materials. Other water-activated adhesives and adhesive compositions known and/or commercially available can be used according to the present invention.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A ground cover or landscaping material that comprises a volume of loose particles and a water activated adhesive component that when activated and cured secures the loose particles together.

2. A ground cover or landscaping material according to claim 1, wherein the volume of loose particles comprises at least one of mulch and wood chips.

3. A ground cover or landscaping material according to claim 1, wherein the volume of loose particles comprises a synthetic material.

4. A ground cover or landscaping material according to claim 1, wherein the volume of loose particles comprises soft or spongy material.

5. A ground cover or landscaping material according to claim 1, wherein the loose particles are coated with the water active adhesive component.

6. A ground cover or landscaping material according to claim 1, wherein the loose particles are impregnated with the water active adhesive component.

7. A ground cover or landscaping material according to claim 5, further comprising an outer water-soluble coating on the adhesive coated particles.

8. A ground cover or landscaping material according to claim 6, further comprising an outer water-soluble coating on the adhesive impregnated particles.

9. A method of applying a ground cover or landscaping material to a surface area which comprises the steps of:
providing a ground cover or landscaping material that comprises a volume of loose particles and a water activated adhesive component that when activated and cured secures the loose particles together;
applying the ground cover or landscaping to a surface area;
applying water to the ground cover or landscaping material to activate the adhesive composition; and
allowing the adhesive composition to cure and fix the loose particles together.

10. A method of applying a ground cover or landscaping material to a surface area according to claim 9, wherein the step of applying water to the ground cover or landscaping material includes allowing the ground cover or landscaping material to become wet by rain.

11. A method of applying a ground cover or landscaping material to a surface area according to claim 9, wherein the surface area comprises an area adjacent at least one of a plant, lawn, building and a pavement.

12. A method of applying a ground cover or landscaping material to a surface area according to claim 11, wherein the surface area comprises an area adjacent at least one of a bush, shrub, tree and flowering plant.

13. A method of applying a ground cover or landscaping material to a surface area according to claim 9, wherein the volume of loose particles comprises at least one of mulch and wood chips.

14. A method of applying a ground cover or landscaping material to a surface area according to claim 9, wherein the volume of loose particles comprises a synthetic material.

15. A method of applying a ground cover or landscaping material to a surface area according to claim 9, wherein the volume of loose particles comprises soft or spongy material.

16. A method of applying a ground cover or landscaping material to a surface area according to claim 9, wherein the loose particles are coated with the water active adhesive component.

17. A method of applying a ground cover or landscaping material to a surface area according to claim 9, wherein the loose particles are impregnated with the water active adhesive component.

18. A method of applying a ground cover or landscaping material to a surface area according to claim 9, wherein the volume of loose particles and the water activated adhesive component are provided separately and combined at the situs of the surface area.

19. A ground cover or landscaping material covering a surface area which comprises a volume of particles that are fixed together by a water activated adhesive that has been water-activated.

20. A ground cover or landscaping material covering a surface area according to claim 19, wherein the particles comprise at least one of mulch, wood chips or a synthetic material.
